(19) United States
(12) Patent Application Publication
(10) Pub. No.: US 2005/0256914 A1
(43) Pub. Date: Nov. 17, 2005

(54) Symbolic links with a plurality of addresses

(75) Inventors: Byron Lewis Bailey, Rochester, MN (US); Robert Douglas Holt, Rochester, MN (US); Jason Allan Nikolai, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/845,567

(22) Filed: May 13, 2004

(51) Int. Cl. G06F 7/00

(52) U.S. Cl. 708/1

(57) ABSTRACT

A method, apparatus, system, and signal-bearing medium that in an embodiment detect accessing of a symbolic link, retrieve a condition from an environment, extract an address from the symbolic link based on the condition, and return a target object based on the address. In this way, a symbolic link may be used to access a variety of target objects.

### FIELD

An embodiment of the invention generally relates to computers. In particular, an embodiment of the invention generally relates to a symbolic link having a plurality of addresses that point to a plurality of target objects.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs.

One of the primary functions of computer programs is the selective storage, retrieval, and manipulation of information. Information in a computer is frequently stored in a hierarchical organization of directories and files. One way that computer programs access information is via symbolic links. A symbolic link is a type of file that contains a pathname to a specified file or other type of object. A pathname is a list of directories that must be followed to reach the specified file. The pathname is not restricted to directories in the current computer, but may also include identifiers of other computer systems attached via a network. When a computer program accesses the symbolic link, the file system of the computer redirects the program to the specified target object to which the symbolic link points.

Symbolic links are used for a wide variety of functions, including (but not limited to) national language support implementations, installation shields, and product media. Many of these functions may need to access different files based upon a criteria, such as a locale, environment, ccsid (coded character set identifier), or some other criteria, but there is no built-in way to accomplish such a task. As a result, either specialized application code must be written to access a different file dynamically based upon some criteria, or a symbolic link must be statically created that restricts the program to one specific file.

Without a way to access a variety of files, programs will not be able to take full advantage of the power of symbolic links.

### SUMMARY

A method, apparatus, system, and signal-bearing medium are provided that in an embodiment detect accessing of a symbolic link, retrieve a condition from an environment, extract an address from the symbolic link based on the condition, and return a target object based on the address. In this way, a symbolic link may be used to access a variety of target objects.

### BRIEF DESCRIPTION OF THE DRAWING

FIG. 1 depicts a block diagram of an example system for implementing an embodiment of the invention.

FIG. 2 depicts a block diagram of an example user interface, according to an embodiment of the invention.

FIG. 3A depicts a block diagram of an example user environment, according to an embodiment of the invention.

FIG. 3B depicts a block diagram of an example n-way symbolic link used to access objects, according to an embodiment of the invention.

FIG. 4 depicts a flowchart of example processing for a file system, according to an embodiment of the invention.

### DETAILED DESCRIPTION

In an embodiment, a n-way symbolic link is created that includes multiple addresses that point to multiple target objects and conditions for choosing between the multiple target objects. When the symbolic link is accessed, a condition is retrieved from an environment, the correct address is extracted from the symbolic link based on the condition, and the corresponding target object is returned based on the address. In this way, a symbolic link may be used to access a variety of target objects.

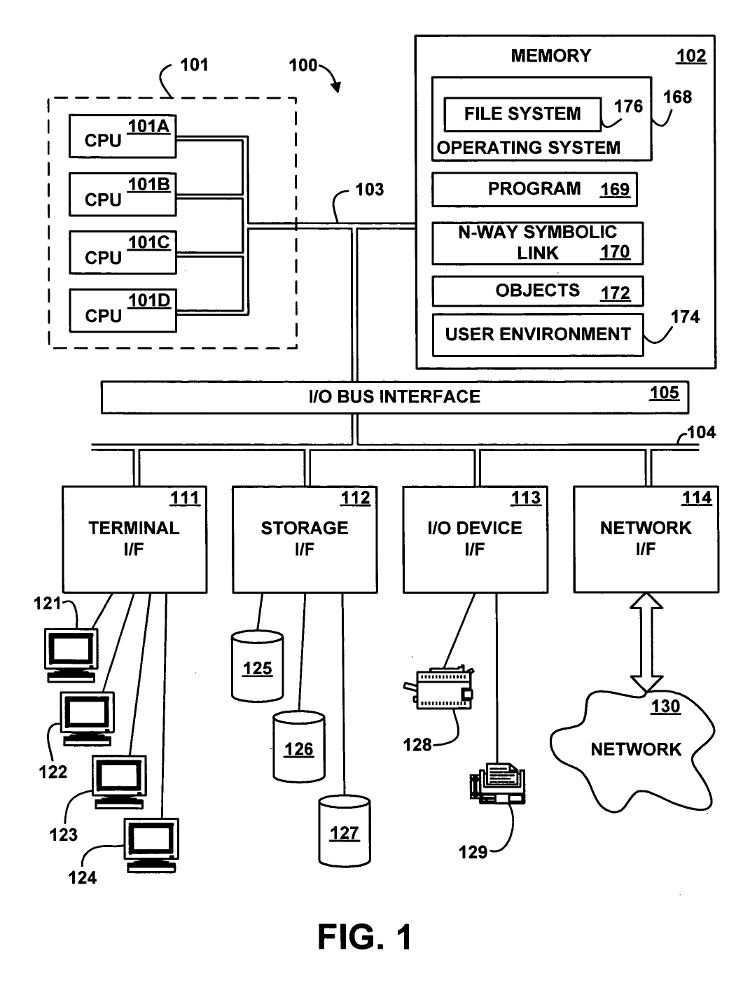

Referring to the Drawing, wherein like numbers denote like parts throughout the several views, FIG. 1 depicts a high-level block diagram representation of a computer system 100, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes an operating system 168, a program 169, a n-way symbolic link 170, objects 172, and a user environment 174. Although the operating system 168, the program 169, the n-way symbolic link 170, the objects 172, and the user environment 174 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the operating system 168, the program 169, the n-way symbolic link 170, the objects 172, and the user environment 174 are illustrated as residing in the memory 102, these elements are not necessarily all completely contained in the same storage device at the same time.

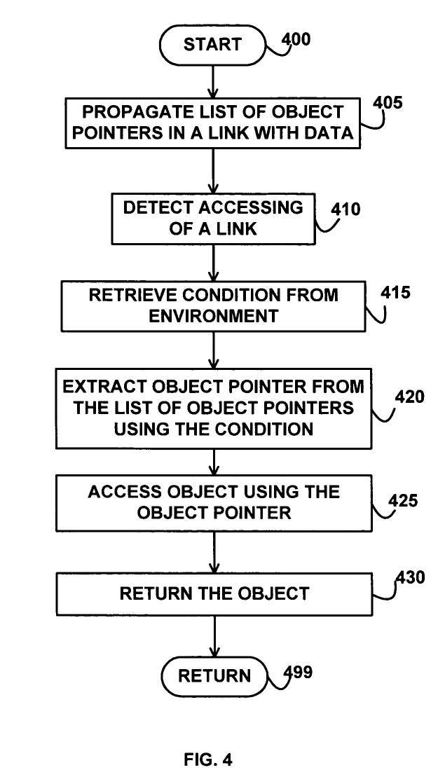

The operating system 168 includes a file system 176. In response to the program 169 accessing the n-way symbolic link 170, the file system 176 determines which of the objects 172 to return to the program 169 based on the n-way symbolic link 170 and the user environment 174. The file system 176 may further propagate the n-way symbolic link 170 with data based on instructions or commands from the program 169. In an embodiment, the file system 176 includes instructions capable of executing on the processor 101 or statements capable of being interpreted by instructions executing on the processor 101 to perform the functions as further described below with reference to FIG. 4. In another embodiment, the file system 176 may be implemented in microcode. In yet another embodiment, the file system 176 may be implemented in hardware via logic gates and/or other appropriate hardware techniques, in lieu of or in addition to a processor-based system.

The program 169 may be any application or operating system function and may access the n-way symbolic link 170 at the direction of a user or independently. In an embodiment, the program 169 issues a command to change the current directory using the n-way symbolic link 170.

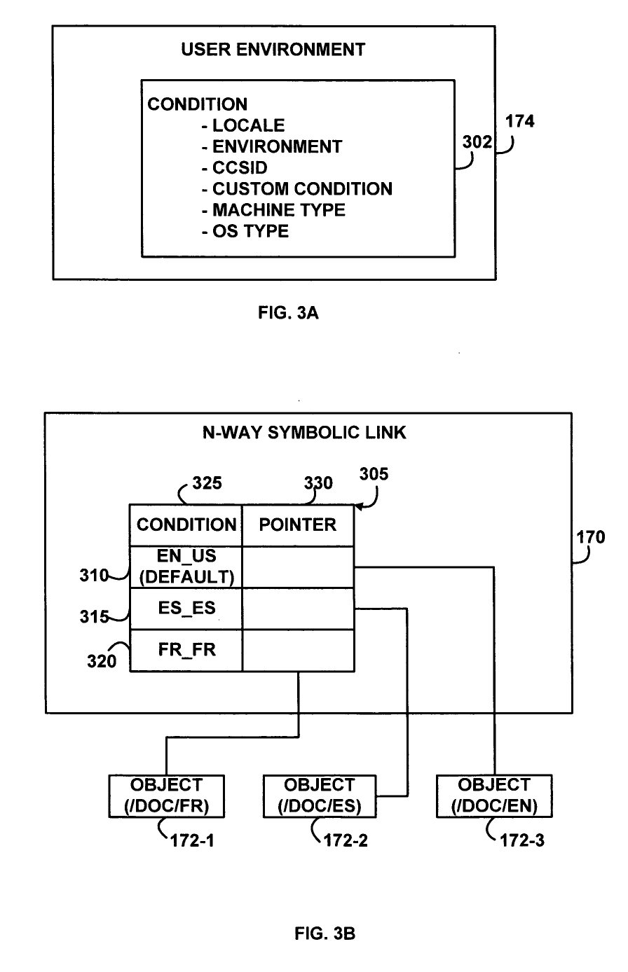

The symbolic link 170 is referred to as “n-way” because it is capable of including a plurality of addresses pointing to a plurality of target objects 172. The n-way symbolic link 170 is further described below with reference to FIG. 3B. The objects 172 may be files, directories, or any other type of objects.

The user environment 174 stores information tailored to the user of the computer system 100. A different user environment 174 may exist for each user, for each category of user, or only one user environment 174 may exist for the entire computer system 100. The user environment 174 is further described below with reference to FIG. 3A.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3 specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

It should be understood that FIG. 1 is intended to depict the representative major components of the computer system 100 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environment illustrated in FIG. 1 are not intended to limit the present invention. Indeed, other alternative hardware and/or software environments may be used without departing from the scope of the invention.

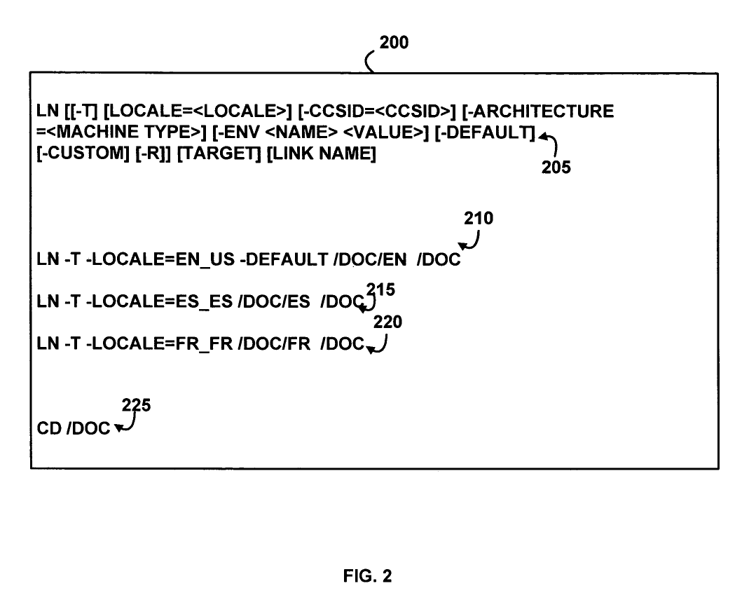

FIG. 2 depicts a block diagram of an example interface 200 for interacting with the file system 176, according to an embodiment of the invention. In an embodiment the interface 200 may be a user interface, but in another embodiment the interface 200 is an API (application program interface). The interface 200 includes an example syntax 205 of a interface command to request that the file system 176 create the typed n-way symbolic link 170:
ln [[-t] [-locale=<locale>] [-ccsid=<ccsid>] [-architecture=<machine type>] [-env <name><value>] [-default] [custom=expr] [-r]] [target] [link name], where:
-t indicates that a typed n-way symbolic link is requested to be created;
-locale indicates that the typed n-way symbolic link is based on a locale;
-ccsid indicates that the typed n-way symbolic link is based on a ccsid value;
-architecture indicates the typed n-way symbolic link is based on the machine architecture;
-env indicates the typed n-way symbolic link is based on an environment;
-default indicates that the target is the default target if the criteria cannot be met;
-custom provides the user with the ability to use a custom expression;
-r indicates that the designated target link name is to be removed;
target indicates the target directory, file, or other object in the objects 172; and
link name is the name of the n-way symbolic link 170;

Locale, ccsid, architecture, and environment are all conditions that the symbolic link 170 can use to determine the object to return, but in other embodiments any appropriate condition may be used.

The interface 200 further includes example commands 210, 215, and 220, which use the example syntax 205. In the example of FIG. 3, the example commands 210, 215, and 220 are used to accommodate three respective groups of users of the computer system 100. The three groups of users speak English, Spanish, and French, and documentation exists for all three languages in three different directories.

Thus, the example command 210 requests the file system 176 to create a typed n-way symbolic link 170 having a locale condition of “en_US,” which, in this example, is the default, with the target directory being “doc/en” and the name of the n-way symbolic link 170 being “/doc.” The example command 215 requests the file system 176 to create a typed n-way symbolic link having a locale condition of “es_ES” with the target directory being “doc/es” and the name of the n-way symbolic link 170 being “/doc.” The example command 220 requests the file system 176 to create a typed n-way symbolic link having a locale condition of “fr_FR” with the target directory being “doc/fr” and the name of the n-way symbolic link 170 being “/doc.” Since all of the commands 210, 215, and 220 specify the same link name (“/doc” in this example), the file system 176 creates a single symbolic link 170 having pointers for each of the pathnames of the target directories, which may be selected by a locale specified in the user environment 174. Thus, when the program 169 of the computer system 100 access the n-way symbolic link 170 via the command 225 (a change directory command), the file system 176 retrieves the locale (en_US) from the user environment 174, and uses it to determine the correct target object 172.

The syntax, commands, and data illustrated in FIG. 2 are exemplary only, and in other embodiments any appropriate syntax, commands, and data may be used.

FIG. 3A depicts a block diagram of an example user environment 174, according to an embodiment of the invention. The user environment 174 includes a condition 302. The condition 302 may indicate a locale, environment, ccsid (coded character set identifier), custom condition, machine type, operating system type, or any other type of condition. Using the example data of FIG. 3A, the condition 302 may include en_US corresponding to an English-speaking user, es_ES corresponding to a Spanish-speaking user, or fr_FR corresponding to a French-speaking user, but in other embodiments any appropriate data may be used. Based on the condition 302, the file system 176 determines which target object in the objects 172 to access when the file system 176 detects that the program 169 accesses the n-way symbolic link 170.

FIG. 3B depicts a block diagram of an example n-way symbolic link 170 used to access a variety of different target objects 172, such as the objects 172-1, 172-2, and 172-3, according to an embodiment of the invention. The n-way symbolic link 170 includes a list of object addresses 305. The list of object addresses 305 includes entries 310, 315, and 320, which correspond to the respective commands 210, 215, and 220 in the example of FIG. 2. But, in other embodiments any number of entries with any appropriate data may be present.

Each of the entries 310, 315, and 320 includes a condition field 325 and a pointer or address field 330. The condition field 325 includes a condition or criteria that may be used to select among the pointers 330. Using the example data of FIG. 2, the condition field stores the locale data indicated specified by the commands 210, 215, and 220. But in other embodiments any appropriate type of data (whether locale, ccsid, architecture, machine type, environment, or any other type) may be used. The pointer field 330 includes an address or pointer to the appropriate object 172 that is associated with the corresponding condition. In the example shown, the pointer field 330 in the entry 310 points to the object 172-3, which is the “/doc/en” target directory; the pointer field 330 in the entry 315 points to the object 172-2, which is the “/doc/es” target directory; and the pointer field 330 in the entry 320 points to the object 172-1, which is the “/doc/fr” target directory. The objects 172-1, 172-2, and/or 172-3 may be within the computer system 100 or on another computer system accessed via the network 130.

FIG. 4 depicts a flowchart of example processing for the file system 176, according to an embodiment of the invention. Control begins at block 400. Control then continues to block 405 where the file system 176 creates the n-way symbolic link 170 and propagates data into the fields 325 and 330 of the list of object addresses 305 in response to commands, such as the commands 210, 215, and 220 in the example of FIGS. 2 and 3B.

Control then continues to block 410 where the file system 176 detects accessing of the n-way symbolic link 170 by the program 169. An example of accessing the n-way symbolic link 170 is illustrated in FIG. 2 as the command 225, the change directory command. Control then continues to block 415 where the file system 176 retrieves the condition 302 from the user environment 174 if the value for the condition 302 exists.

Control then continues to block 420 where the file system 176 extracts the object pointer or address 330 using the condition 302 and the list of object addresses 305. If the condition 302 does not exist, then the file system 176 uses the default condition, which in the example of FIG. 3B is included in the entry 310, as specified by the command 210 in FIG. 2. Control then continues to block 425 where the file system 176 accesses the object 172 using the object pointer 330. Control then continues to block 430 where the file system 176 returns the accessed object to the program 169.

Control then continues to block 499 where the logic of FIG. 4 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

1. A method comprising:
detecting accessing of a symbolic link, wherein the symbolic link comprises a plurality of addresses;
retrieving a condition from an environment;
extracting one of the plurality of addresses based on the condition; and
returning a target object based on the one of the plurality of addresses.

2. The method of claim 1, wherein a type of the condition is selected from a group consisting of: a locale, an environment, a coded character set identifier, and a machine type.

3. The method of claim 1, wherein the target object further comprises a directory.

4. The method of claim 1, further comprising:
propagating the symbolic link with the plurality of addresses.

5. An apparatus comprising:
means for detecting accessing of a symbolic link, wherein the symbolic link comprises a plurality of addresses;
means for determining whether a condition exists in an environment;
means for retrieving the condition from the environment if the condition exits in the environment;
means for extracting one of the plurality of addresses based on the condition; and
means for returning a target object based on the one of the plurality of addresses.

6. The apparatus of claim 5, wherein a type of the condition is selected from a group consisting of: a locale, an environment, a coded character set identifier, and a machine type.

7. The apparatus of claim 5, wherein the target object further comprises a directory.

8. The apparatus of claim 5, further comprising:
means for propagating the symbolic link with the plurality of addresses.

9. A signal-bearing medium encoded with instructions, wherein the instructions when executed comprise:
detecting accessing of a symbolic link, wherein the symbolic link comprises a plurality of addresses;
determining whether a condition exists in an environment;
retrieving the condition from the environment if the condition exits in the environment;
determining the condition from a default in the symbolic link if the condition does not exist in the environment;
extracting one of the plurality of addresses based on the condition; and
returning a target object based on the one of the plurality of addresses.

10. The signal-bearing medium of claim 9, wherein a type of the condition is selected from a group consisting of: a locale, an environment, a coded character set identifier, and a machine type.

11. The signal-bearing medium of claim 9, wherein the target object further comprises a directory.

12. The signal-bearing medium of claim 9, further comprising:
propagating the symbolic link with the plurality of addresses.

13. A computer system comprising:
a processor; and
memory encoded with instructions, wherein the instructions when executed on the processor comprise:
detecting accessing of a symbolic link, wherein the symbolic link comprises a plurality of addresses and the accessing comprises a change directory command,
determining whether a condition exists in an environment,
retrieving the condition from the environment if the condition exits in the environment,
determining the condition from a default in the symbolic link if the condition does not exist in the environment,
extracting one of the plurality of addresses based on the condition, and
returning a target object based on the one of the plurality of addresses.

14. The computer system of claim 13, wherein a type of the condition is selected from a group consisting of: a locale, an environment, a coded character set identifier, and a machine type.

15. The computer system of claim 13, wherein the target object further comprises a directory.

16. The computer system of claim 13, wherein the instructions further comprise:
propagating the symbolic link with the plurality of addresses.

17. A method for configuring a computer, wherein the method comprises:
configuring the computer to detect accessing of a symbolic link, wherein the symbolic link comprises a plurality of addresses;
configuring the computer to retrieve a condition from an environment;
configuring the computer to extract one of the plurality of addresses based on the condition; and
configuring the computer to return a target object based on the one of the plurality of addresses.

18. The method of claim 17, wherein a type of the condition is selected from a group consisting of: a locale, an environment, a coded character set identifier, and a machine type.

19. The method of claim 17, wherein the target object further comprises a directory.

20. The method of claim 17, further comprising:
configuring the computer to propagate the symbolic link with the plurality of address.
